(19) United States
(12) Patent Application Publication
(10) Pub. No.: US 2009/0212058 A1
(43) Pub. Date: Aug. 27, 2009

(54) Cartridge for pressurized fluid

(75) Inventors: Eric Carrato, Chaussan (FR); Yann Devines, Saint Genis Laval (FR)

Correspondence Address: Kelly S. K. Elsea;The Coleman Company, Inc., 3600 N. Hydraulic, Wichita, KS, 67219, US

(73) Assignee: Application Des Gaz, Saint Genis Laval (FR)

(21) Appl. No.: 11/908,219

(22) PCT Filed: Oct. 24, 2005
(86) PCT No.: PCT/FR05/02648

§ 371 Date: Feb. 6, 2008

(30) Foreign Application Priority Data
Mar. 24, 2005 (FR) 0502934

(51) Int. Cl. F17C 1/00

(52) U.S. Cl. 220/581

(57) ABSTRACT

A cartridge for pressurized fluid. The cartridge includes a body having a cylindrical portion and a bottom having a concavity oriented toward the inside of the body. The connection between the bottom and the body is made by an annular seam. The particular structure of the connection zone provides a reduction in the diameter of the body for connection to a bottom of lesser diameter without creating zones of concentration of stresses. Another arrangement of the cartridge provides for the bottom to have a cylindrical portion that bears against the cylindrical end portion of the body, which makes it possible to create a rigid zone.

The present invention relates to a cartridge for pressurized fluid.

### BACKGROUND OF THE INVENTION

The packaging of a pressurized fluid, particularly liquefied petroleum gas such as butane, may be made in the form of cartridges. These cartridges may be coupled to apparatus of different types—stove, lighting lamp, blowtorch, etc.—which, to operate, use the gas stored in the cartridge.

Usually, a cartridge comprises a metal body with a cylindrical wall having, at its bottom end, an opening that is closed off by a bottom. The bottom is of concave shape and is attached to the body by swaging.

The fluid contained in the cartridge—usually a combustible gas—may be drawn off according to two possibilities:
it is possible to provide a perforable cartridge, that is to say a cartridge whose body is completely closed. The top portion of the body comprises a perforation zone, where a perforator belonging to an apparatus can pierce the cartridge in order to draw off the fluid.
it is also possible to provide a cartridge with a valve, that is to say a cartridge that incorporates in the top portion a gas offtake valve. This type of cartridge has a higher level of safety than that of the cartridges that can be perforated.

Naturally, each type of cartridge has specific diameters, such that an apparatus designed to operate with a perforable cartridge cannot be used with a cartridge that has a valve and vice versa.

For the purpose of developing a new cartridge, the reuse of pre-existing elements is naturally favorable from an economic point of view since it is not necessary to manufacture new tools.

In particular, in the context of the development of a cartridge with a valve, it may be found worthwhile to use the bottom of a perforable cartridge. Specifically, perforable cartridges are manufactured in millions of units each year and the toolage for manufacturing the latter is largely amortized.

However, the reuse of a bottom dimensioned for a perforable cartridge by a cartridge with a valve poses a problem because a cartridge with a valve must necessarily have a diameter that is different from that of a perforable cartridge. This difference in diameter creates an incompatibility with apparatus dimensioned to receive a perforable cartridge.

In practice, a perforable cartridge has a diameter of 86 millimeters while a similar capacity cartridge with a valve must have a body of a diameter greater than 91 millimeters to create an incompatibility with the apparatus, currently existing on the market, designed to operate with perforable cartridges.

It can be seen therefore that, if it is desired to use a pre-existing bottom of smaller diameter than that of the body, the latter must have a wall of changeable shape to be able to be connected to the bottom. The use of a body of cylindrical section can therefore be envisioned.

The reduction of the body diameter in order to adapt to a pre-existing bottom may have a negative influence on the capacity of the cartridge to withstand the pressure forces of the pressurized fluid. In other words, the change of the body diameter may create concentrations of stress which, in certain conditions, may cause inadmissible deformations of the cartridge.

One object of the invention is to propose a cartridge for packaging pressurized fluid that has a reduction in diameter and that has good pressure-resistance performance.

### SUMMARY OF THE INVENTION

The main subject of the invention is a cartridge for pressurized fluid comprising:
a body having a cylindrical portion of diameter D lying between 75 mm and 110 mm surmounted by a dome at one of its ends and a circular opening at its second end, and
a bottom of diameter d lying between 70 mm and 90 mm and less than the diameter D closing the opening of the body, the bottom having a concavity oriented toward the inside of the body, the connection between the bottom and the body being made by an annular seam, characterized in that the body has, in its portion adjacent to the opening, a connection zone A comprising:
a cylindrical end portion of a height h of diameter equal to the diameter of the bottom,
a frustoconical portion connecting the cylindrical end portion to the cylindrical body,
   the frustoconical portion forming an angle α with the cylindrical end portion, α lying between 10 and 30°, and the height h of the cylindrical end portion lying between 3 and 10 millimeters.

The particular structure of the connection zone means that the reduction in the diameter of the body for connection to a bottom of lesser diameter is obtained without creating zones of concentration of stresses.

According to other features of the cartridge:
the radius R1 of connection of the frustoconical portion to the cylindrical portion lies between 2 and 20 millimeters, and
the radius R2 of connection of the frustoconical portion to the cylindrical end portion lies between 2 and 20 millimeters.

Preferably, the angle α lies between 12° and 18°.

In particular, the angle α is equal to 15°; this value is in effect a good compromise between the minimization of stress peaks and a frustoconical portion that has too great a height.

Another arrangement of the cartridge provides for the bottom to have a cylindrical portion that bears against the cylindrical end portion of the body, which makes it possible to create a rigid zone.

Preferably, the cylindrical end portion h has a height of 5 millimeters.

Preferably, the radius R1 of connection is of the order of 10 millimeters and the radius R2 of connection is of the order of 10 millimeters.

So that it can be fully understood, the invention is described with reference to the appended drawing showing, as a nonlimiting example, one embodiment of a cartridge according thereto.

### BRIEF DESCRIPTION OF THE DRAWINGS

FIG. 1 represents, in axial section, a cartridge according to the invention,

FIG. 2 represents, on an enlarged scale, the portion of the cartridge situated at its base.

### DESCRIPTION OF THE PREFERRED EMBODIMENTS

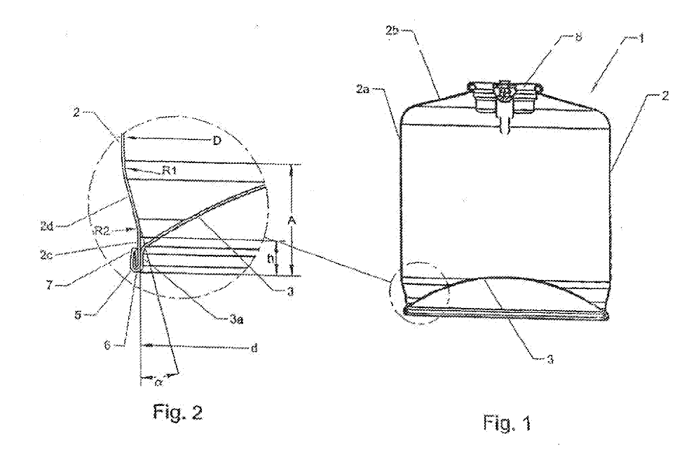

As shown in FIG. 1, the cartridge 1 comprises two main elements, namely a body 2 and a bottom 3.

The body consists of a metal sheet that is structured so as to have a cylindrical portion 2a surmounted by a dome 2b.

The dome 2b receives a valve 8 capable of interacting with an apparatus using a fluid contained in the cartridge. The valve is attached to the body by beading.

The bottom 3 consists of a concave metal cup that closes off the body.

The bottom 3 is attached to the body 2 by swaging.

As is shown more clearly in FIG. 2, the body is structured to have an annular hook 5, while the bottom 3 is structured to have an annular arc 6 extended by an annular hook 7. The respective annular hooks 5 and 7 of the body 2 and of the bottom 3 are nested in one another to form the mechanical connection between the body 2 and the bottom 3.

The particular feature of the cartridge according to the invention is that the diameter of the bottom is less than the diameter of the cylindrical portion of the body.

The body therefore has a connection zone A.

A first point to note is that the connection zone A is adjacent to the opening of the body 2. This arrangement makes it possible specifically to use tools that work close to the opening; it is in effect the zone that has the best accessibility for the tools that have to perform a hammering operation.

Secondly, it should be noted that the connection zone A has a very specific profile for reasons that will be explained below.

Specifically, provision is made for the connection zone to be divided into:
a cylindrical end portion 2c with a diameter equal to the diameter of the bottom; the cylindrical end portion has a height h,
a frustoconical portion 2d that makes the connection between the cylindrical end portion 2c and the cylindrical portion of the body.

It should be noted that the cartridge is designed to receive a fluid whose pressure is greater than atmospheric pressure. The fluid is present in the cartridge in a gaseous phase and in a liquid phase.

Note that, before exploding, a gas cartridge sustains a permanent mechanical deformation under the effect of an increase in gas pressure; this deformation is an inversion of the bottom, that is to say a change of concavity of the latter that makes it possible to increase the volume inside the cartridge while retaining its seal.

The specifics of the connection zone of the cartridge according to the invention mean that the reduction in diameter does not disrupt the behavior of the cartridge; specifically the variations of section form zones of concentration of stresses.

Therefore, provision is made for the height h of the cylindrical end portion to lie between 3 and 10 millimeters; this arrangement allows the bottom 3 to have a cylindrical portion 3a that bears directly against the cylindrical end portion 2c of the body 2.

Provision is also made for the angle that the frustoconical portion forms with the cylindrical end portion to lie between 10 and 30°. This relatively flat angle makes it possible to minimize the formation of stress peaks that are generated by the discontinuities due to the variations in diameter.

Preferably, the angle α lies between 12 and 18° that corresponds to a satisfactory compromise between the minimization of the stress peaks and having a frustoconical portion that has too great a height, which would be difficult to produce industrially. The preferred value of the angle α may be evaluated at 15°.

The radii R1 and R2 respectively of connection of the frustoconical portion 2d to the cylindrical portion 2a of the body and of the frustoconical portion to the cylindrical end portion lie between 2 and 20 millimeters. The preferred value of the radii R1 and R2 is of the order of 10 millimeters.

It can be seen therefore that all the parameters defining the connection zone help to create a zone in which the concentrations of stresses are minimized.

In addition to the advantage of being able to use a possibly pre-existing bottom of smaller diameter than the diameter of the body, an additional advantage is noted for the cartridge according to the invention which lies in the fact that the swaging that forms a bulge lies radially within the diameter of the body.

Because of this, the cartridges according to the invention may be stored one against the other without the swaging creating an interference.

1. A cartridge for pressurized fluid comprising:
a body having a cylindrical portion of diameter D lying between 75 millimeters and 110 millimeters surmounted by a dome at one of its ends and a circular opening at its second end, and
a bottom of diameter d less than the diameter D closing the opening of the body, the bottom having a concavity oriented toward the inside of the body, the connection between the bottom and the body being made by an annular seam,
characterized in that the body has, in its portion adjacent to the opening, a connection zone A comprising:
a cylindrical end portion of a height h of diameter equal to the diameter of the bottom,
a frustoconical portion connecting the cylindrical end portion to the cylindrical body, the frustoconical portion forming an angle α with the cylindrical end portion, α lying between 10 and 30°, and the height h of the cylindrical end portion lying between 3 and 10 millimeters.

2. The cartridge as claimed in claim 1, characterized in that the radius R1 of connection of the frustoconical portion to the cylindrical portion lies between 2 and 20 millimeters.

3. The cartridge as claimed in claim 1 or claim 2, characterized in that the radius R2 of connection of the frustoconical portion to the cylindrical end portion lies between 2 and 20 millimeters.

4. The cartridge as claimed in one of claims 1 to 3, characterized in that the angle α lies between 12° and 18°.

5. The cartridge as claimed in one of claims 1 to 4, characterized in that the angle α is equal to 15°.

6. The cartridge as claimed in one of claims 1 to 5, characterized in that the bottom has a cylindrical portion that bears against the cylindrical end portion of the body.

7. The cartridge as claimed in one of claims 1 to 6, characterized in that the cylindrical end portion has a height of 5 millimeters.

8. The cartridge as claimed in one of claims 2 to 7, characterized in that the radius R1 of connection is of the order of 10 millimeters.

9. The cartridge as claimed in one of claims 3 to 8, characterized in that the radius R2 of connection is of the order of 10 millimeters.
